(19) United States
(12) Patent Application Publication
(10) Pub. No.: US 2014/0055417 A1
(43) Pub. Date: Feb. 27, 2014

(54) DISPLAY MODULE

(71) Applicants: WINTEK CORPORATION, Taichung City (TW); Dongguan Masstop Liquid Crystal Display Co., Ltd., Dongguan City (TW)

(72) Inventors: Wei-Chou Chen, Hsinchu City (TW); Chong-Yang Fang, Taichung City (TW); Kuo-Chang Su, Taichung City (TW)

(73) Assignees: WINTEK CORPORATION, Taichung City (TW); Dongguan Masstop Liquid Crystal Display Co., Ltd., Dongguan City (CN)

(21) Appl. No.: 13/970,622

(22) Filed: Aug. 20, 2013

(30) Foreign Application Priority Data
Aug. 21, 2012 (TW) 101130235

(51) Int. Cl. G06F 3/042

(52) U.S. Cl. CPC G06F 3/0425
USPC 345/175

(57) ABSTRACT

A display module includes a touch device, a cover lens, a decoration layer, at least one optical module, and a display panel. The touch device is arranged at a lower side of the cover lens for generating a touch signal. The decoration layer is arranged under the cover lens, and has a first hole and at least one second hole, wherein the touch device corresponds to the first hole, and the first hole is larger than the at least one second hole. The at least one optical module is arranged under the cover lens and corresponding to the at least one second hole, for generating an image signal. The display panel is arranged under the decoration layer and the touch device for executing a corresponding operation according to the touch signal or the image signal.

### BACKGROUND OF THE INVENTION

1. Field of the Invention

The present invention relates to a display module, and more particularly, to a display module integrating a 2D touch control function with a 3D remote control function, and having advantages of light weight, cost saving and power saving.

2. Description of the Prior Art

Please refer to FIG. 1. FIG. 1 is a diagram showing a display module 100 of the prior art. As shown in FIG. 1, the display module 100 comprises a 2D touch panel 102, a 3D remote control unit 104, a signal processor 106 and a display panel 108. As shown in FIG. 1, the 2D touch panel 102 is arranged above the display panel 108, and the 3D remote control unit 104 is arranged separately from the 2D touch panel 102 and the display panel 108, wherein a touch signal generated by the 2D touch panel 102 and an image signal generated by the 3D remote control unit 104 are transmitted to the signal processor 106. Thereafter, the signal processor 106 determines to first process the touch signal or the image signal. In addition, the 2D touch panel 102 and the 3D remote control unit 104 need a calibration mechanism, in order to prevent inconsistency between a touch control point generated by the touch signal and a touch control point generated by the image signal when the touch signal generated by the 2D touch panel 102 and the image signal generated by the 3D remote control unit 104 are interchanged with each other.

Therefore, the display module 100 has the following disadvantages: first, the display module 100 has heavier weight and higher cost since the 2D touch panel 102, the 3D remote control unit 104 and the signal processor 106 are not integrated together; and second, the display module 100 has larger power consumption since the 2D touch panel 102 and the 3D remote control unit work simultaneously.

### SUMMARY OF THE INVENTION

An embodiment of the present invention provides a display module, which comprises a touch device, a cover lens, a decoration layer, at least one optical module, and a display panel. The touch device is arranged at a lower side of the cover lens, for generating a touch signal. The decoration layer is arranged under the cover lens, and has a first hole and at least one second hole, wherein the touch device corresponds to the first hole, and the first hole is larger than the at least one second hole. The at least one optical module is arranged under the cover lens and corresponding to the at least one second hole, for generating an image signal. The display panel is arranged under the decoration layer and the touch device for executing a corresponding operation according to the touch signal or the image signal.

Another embodiment of the present invention provides a display module, which comprises a cover lens, a decoration layer, a touch device, at least one optical module, and a display panel. The decoration layer is arranged under the cover lens, and has a first hole and at least one second hole, wherein the first hole is larger than the at least one second hole. The display panel is arranged under the decoration layer. The touch device is arranged above the display panel and corresponding to the first hole, for generating a touch signal. The at least one optical module is arranged under the cover lens and corresponding to the at least one second hole, for generating an image signal. The display panel is for executing a corresponding operation according to the touch signal or the image signal.

The present invention provides a display module integrating a 2D touch control function (a touch device) with a 3D remote control function (at least one optical module), therefore, in contrast to the prior art, the present invention has the following advantages:

first, the display module of the present invention is lighter; second, the display module has lower cost since the display module integrates the 2D touch control function with the 3D remote control function to reduce signal interfaces of the display module; third, calibration of the display module becomes easier since the display module integrates the 2D touch control function with the 3D remote control function; and fourth, the display module is power saving since the 2D touch control function and the 3D remote control function may not be activated simultaneously.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a display module 100 of the prior art.

FIG. 2 is a cross-sectional view of a section A-A′ of a display module according to an embodiment of the present invention.

FIG. 3 is across-sectional view of a section B-B′ of the display module.

FIG. 4 is top view of the display module.

FIG. 5, FIG. 6 and FIG. 7 are diagrams showing different embodiments of the processor of the present invention.

FIG. 8 is a cross-sectional view of a section A-A′ of a display module according to another embodiment of the present invention.

FIG. 9 is across-sectional view of a section B-B′ of the display module.

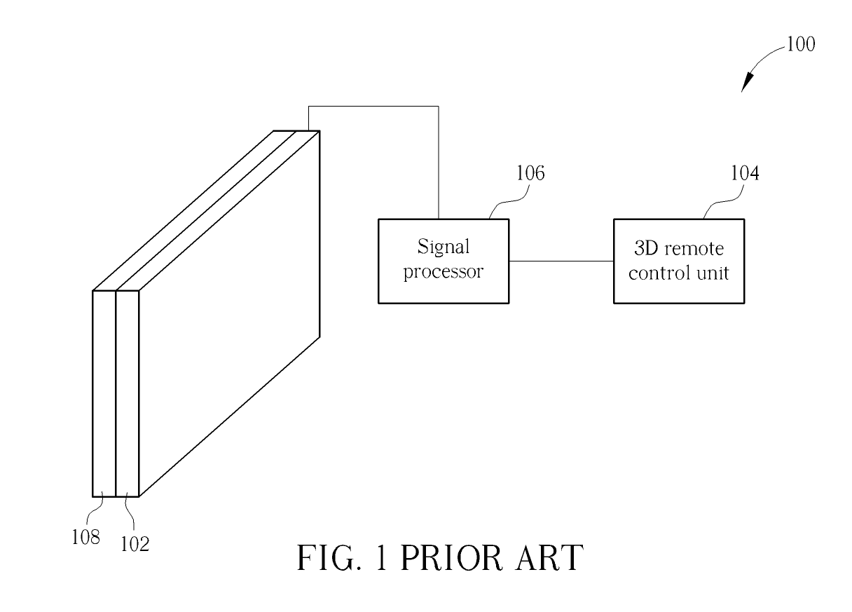

### DETAILED DESCRIPTION

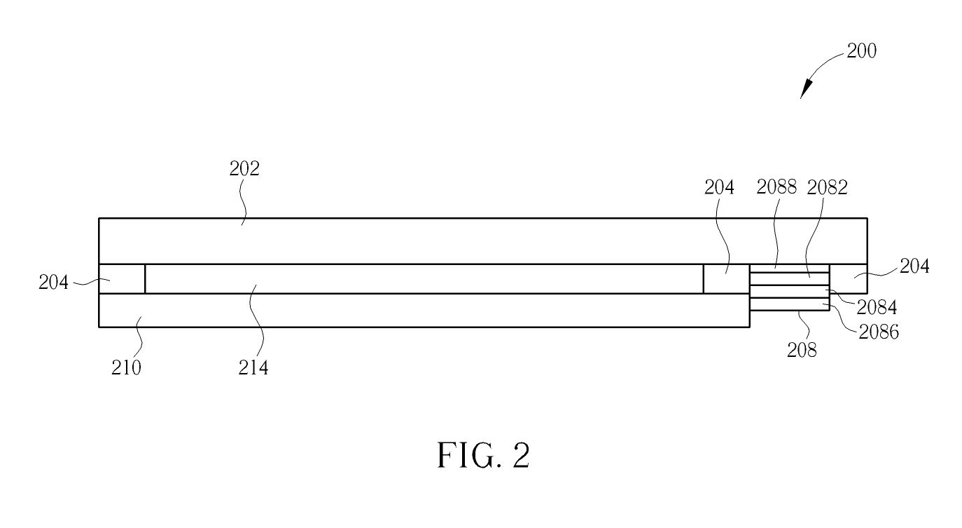

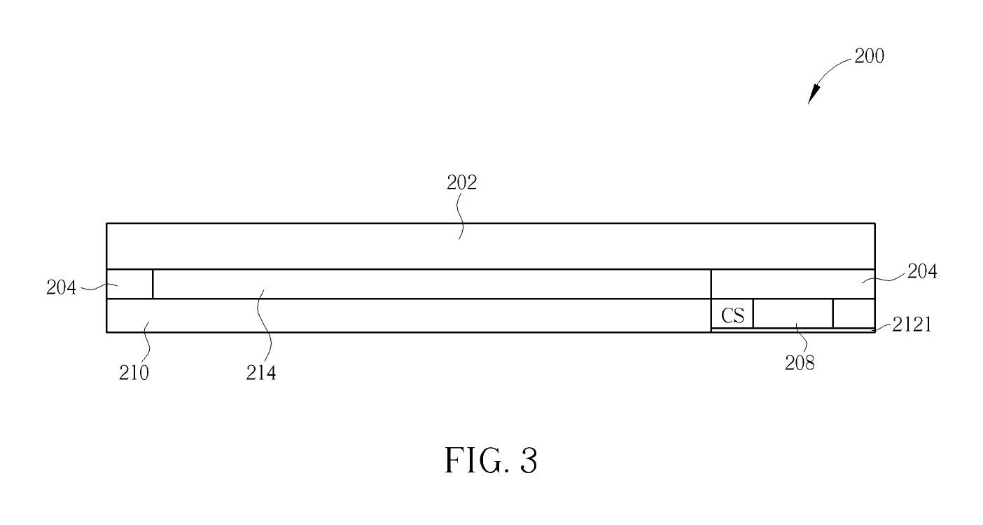

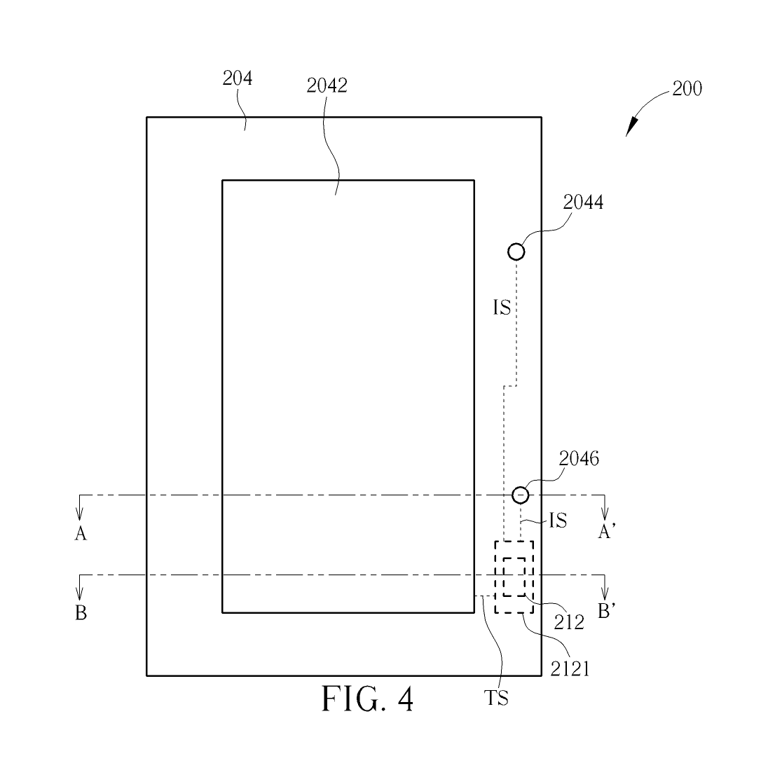

Please refer to FIG. 2 to FIG. 4. FIG. 2 is a cross-sectional view of a section A-A′ of a display module 200 according to an embodiment of the present invention. FIG. 3 is a cross-sectional view of a section B-B′ of the display module 200. FIG. 4 is top view of the display module 200. The display module 200 comprises a cover lens 202 (shown in FIG. 2 and FIG. 3), a decoration layer 204 (shown in FIG. 2 to FIG. 4), an optical module 208 (shown in FIG. 2 and FIG. 3), a display panel 210 (shown in FIG. 2 and FIG. 3) and a processor 212 (shown in FIG. 4). As shown in FIG. 2 and FIG. 3, a touch device 214 is arranged at a lower side of the cover lens 202, wherein the touch device 214 is configured to generate a touch signal TS. The decoration layer 204 is arranged under the cover lens 202, and has a first hole 2042 and two second holes 2044, 2046, wherein the touch device 214 corresponds to the first hole 2043. The optical module 208 is arranged under the cover lens 202 and corresponding to the second hole 2046, for generating an image signal IS, wherein the optical module 208 can be a charge coupled device (CCD) sensor or a complementary metal oxide semiconductor (CMOS) sensor. The processor 212 is coupled to the touch device 214 and the optical module 208 through a printed circuit board 2121, for receiving and processing the touch signal TS generated by the touch device 214 and the image signal IS generated by the optical module 208, and generating a control signal CS according to the touch signal TS generated by the touch device 214 or the image signal IS generated by the optical module 208 (the control signal CS is a control signal generated by the processor 212 and transmitted to the display panel 210), wherein the printed circuit board 2121 is a flexible printed circuit board. The display panel 210 is arranged under the decoration layer 204 and the touch device 214 for executing a corresponding operation according to the control signal CS generated by the processor 212, wherein an active area of the display panel 210 corresponds to the first hole 2042.

As shown in FIG. 2, the optical module 208 comprises a lens 2082, an image sensor 2084, an image processor 2086 and an infrared light filter 2088. The infrared light filter 2088 is attached between the cover lens 202 and the lens 2082 for filtering out infrared light generated from at least one object. The lens 2082 is arranged under the cover lens 202 for receiving light (without infrared light) generated from at least one object via the second hole 2046. The image sensor 2084 is arranged under the lens 2082 for sensing the light generated from the at least one object, and generating a sensing signal according to the light generated from the at least one object. The image processor 2086 is coupled to the image sensor 2084 for performing image processing to generate the image signal IS according to the sensing signal generated by the image sensor 2084. Therefore, the image signal IS generated by the optical module 208 can be transmitted to the processor 212 through a wire (not shown in FIG. 2) under the decoration layer 204, or through a wire (not shown in FIG. 2) integrated with the touch device 214. In addition, in another embodiment of the present invention, the infrared light filter 2088 is integrated into the cover lens. Moreover, another optical module (not shown) can be also arranged under the cover lens 202 and corresponding to the second hole 2044. But the present invention is not limited to the display module 200 comprising two optical modules, the display module 200 can comprise at least one optical modules. Furthermore, the optical module corresponding to the second hole 2044 is identical to the optical module 208, therefore, the optical module corresponding to the second hole 2044 is not further illustrated.

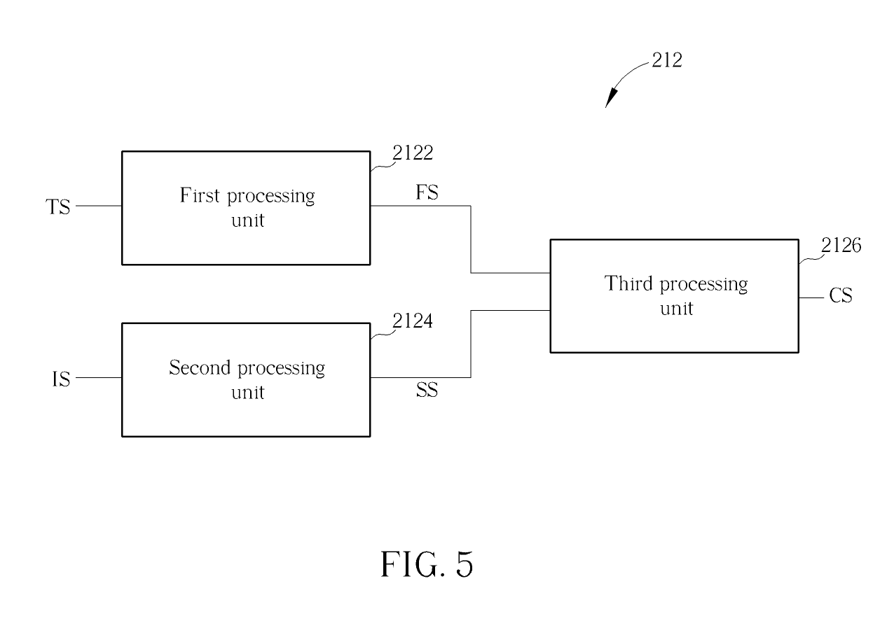

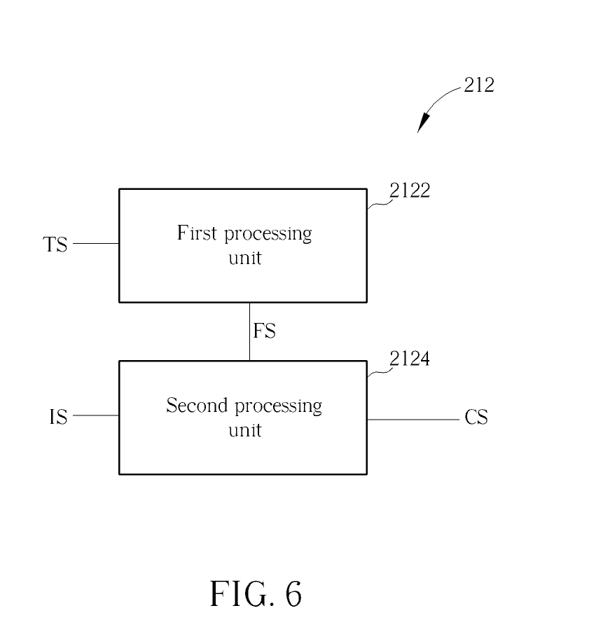

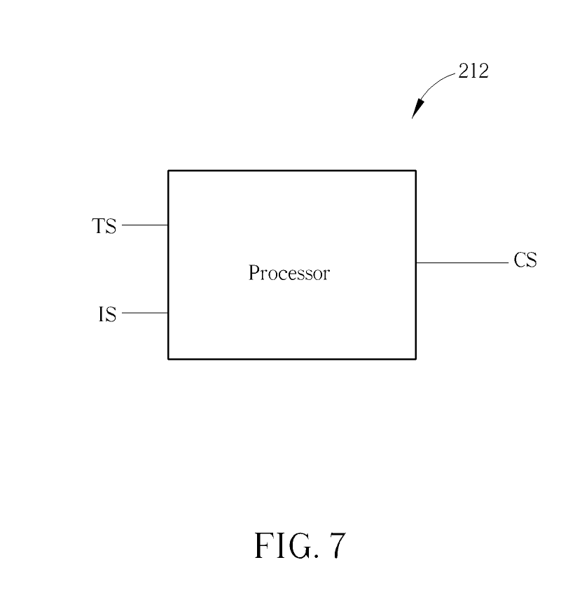

Please refer to FIG. 5, FIG. 6 and FIG. 7. FIG. 5, FIG. 6 and FIG. 7 are diagrams showing different embodiments of the processor 212 of the present invention. As shown in FIG. 5, the processor 212 comprises a first processing unit 2122, a second processing unit 2124 and a third processing unit 2126. The first processing unit 2122 is configured to receive the touch signal TS, and process and position the touch signal TS, for generating a first signal FS. The second processing unit 2124 is configured to receive the image signal IS, and process and position the image signal IS, for generating a second signal SS. The third processing unit 2126 is coupled to the first processing unit 2122 and the second processing unit 2124, for receiving and processing the first signal FS or the second signal SS, and generating the control signal CS according to the first signal FS or the second signal SS. That is, when the processor 212 receives the touch signal TS, the processor 212 determines the display module 200 is in a 2D touch control mode, thus the processor 212 turns off the optical module 208 and the other optical module, such that the third processing unit 2126 receives the first signal FS, and generates the control signal CS according to the first signal FS; when the processor 212 receives the image signal IS, the processor 212 determines the display module 200 is in a 3D remote control mode, thus the processor 212 turns off a sensor of the touch device 214, such that the third processing unit 2126 receives the second signal SS, and generates the control signal CS according to the second signal SS. However, when the processor 212 receives a touch signal TS and an image signal IS generated from an object at the same time, the processor 212 may ignore the image signal IS.

As shown in FIG. 6, the processor 212 comprises a first processing unit 2122 and a second processing unit 2124, wherein the second processing unit 2124 is an image processing unit with powerful capability, such that the second processing unit 2124 can replace the third processing unit 2126 in FIG. 5. The first processing unit is configured to receive the touch signal TS, and process and position the touch signal TS, for generating a first signal FS. The second processing unit 2124 is coupled to the first processing unit 2122, for receiving the image signal IS or the first signal FS, and generating the control signal CS by processing and positioning the image signal IS or the first signal FS. That is, when the processor 212 receives the touch signal TS, the processor 212 determines the display module 200 is in the 2D touch control mode, thus the processor 212 turns off the optical module 208 and the other optical module, such that the second processing unit 2124 receives the first signal FS, and generates the control signal CS according to the first signal FS; when the processor 212 receives the image signal IS, the processor 212 determines the display module 200 is in the 3D remote control mode, thus the processor 212 turns off the sensor of the touch device 214, such that the second processing unit 2124 receives the image signal IS, and generates the control signal CS according to the image signal IS. However, when the processor 212 receives a touch signal TS and an image signal IS generated from an object at the same time, the processor 212 may ignore the image signal IS.

As shown in FIG. 7, the processor 212 integrates the first processing unit 2122, the second processing unit 2124 and the third processing unit 2126 in FIG. 5 together, therefore, internal signal lines and power lines inside the processor 212 can be simplified. Thus, the processor 212 in FIG. 7 can have smaller size and lower power consumption. In addition, operation theory of the processor 212 in FIG. 7 is identical to operation theory of the processor 212 in FIG. 5, therefore, the operation theory of the processor 212 in FIG. 7 is not further illustrated.

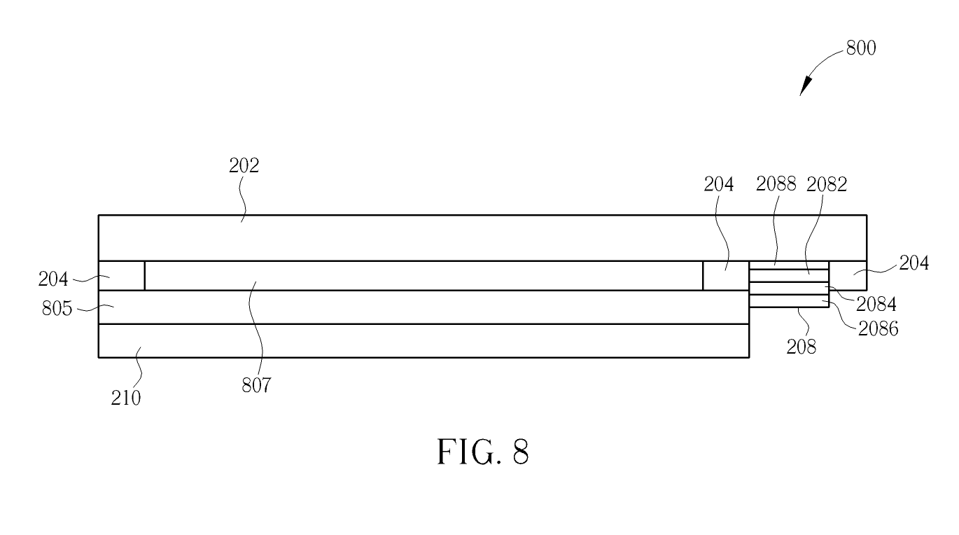

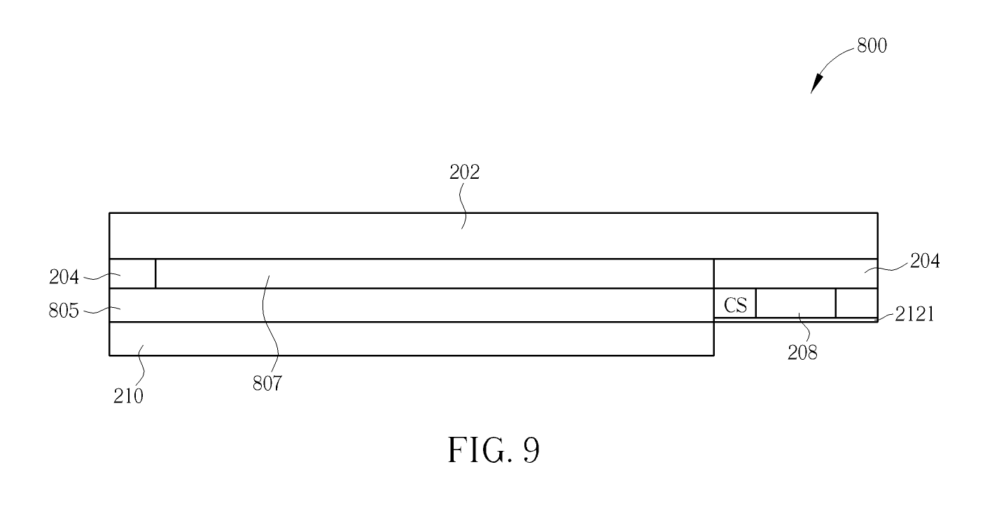

Please refer to FIG. 8 and FIG. 9. FIG. 8 is a cross-sectional view of a section A-A′ of a display module 800 according to another embodiment of the present invention, and FIG. 9 is a cross-sectional view of a section B-B′ of the display module 800, wherein a top view of the display module 800 is identical to the top view of the display module 200. As shown in FIG. 8 and FIG. 9, a difference between the display module 800 and the display module 200 is that the display module 800 utilizes a touch device 805 to generate a touch signal TS. As shown in FIG. 8 and FIG. 9, the touch device 805 is arranged above the display panel 210 for generating the touch signal TS, wherein the first hole 2042 above the touch device 805 can be an air layer or filled with transparent gel 807, that is, the touch device 805 is independent from the cover lens 202. When the processor 212 receives the touch signal TS, the processor 212 determines the display module 200 is in the 2D touch control mode, thus the processor 212 turns off the optical module 208 and the other optical module; when the processor 212 receives the image signal IS, the processor 212 determines the display module 200 is in the 3D remote control mode, thus the processor 212 turns off the sensor of the touch device 805. In addition, operation theory of the display module 800 is identical to operation theory of the display module 200, therefore, the operation theory of the display module 800 is not further illustrated.

Summarizing the above, the display module of the present invention integrates a 2D touch control function (a touch device) with a 3D remote control function (at least one optical module), therefore, in contrast to the prior art, the present invention has the following advantages: first, the display module of the present invention is lighter; second, the display module has lower cost since the display module integrates the 2D touch control function with the 3D remote control function to reduce signal interfaces of the display module; third, calibration of the display module becomes easier since the display module integrates the 2D touch control function with the 3D remote control function; and fourth, the display module is power saving since the 2D touch control function and the 3D remote control function may not be activated simultaneously.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display module, comprising:
a touch device;
a cover lens, wherein the touch device is arranged at a lower side of the cover lens;
a decoration layer, arranged under the cover lens, having a first hole and at least one second hole, wherein the touch device corresponds to the first hole, and the first hole is larger than the at least one second hole;
at least one optical module, arranged under the cover lens and corresponding to the at least one second hole; and
a display panel, arranged under the decoration layer and the touch device.

2. The display module of claim 1, wherein the optical module comprises :
a lens, arranged under the cover lens for receiving light generated from at least one object via the second hole;
an image sensor, arranged under the lens for sensing the light generated from the at least one object, and generating a sensing signal according to the light generated from the at least one object; and
an image processor, for performing image processing to generate an image signal according to the sensing signal.

3. The display module of claim 2, wherein the image sensor is a charge coupled device (CCD) sensor or a complementary metal oxide semiconductor (CMOS) sensor.

4. The display module of claim 2, wherein the optical module further comprises:
an infrared light filter, attached between the cover lens and the lens for filtering out infrared light generated from the at least one object.

5. The display module of claim 1 further comprising:
a processor, coupled to the touch device and the optical module through a printed circuit board, for receiving and processing a touch signal and an image signal, and generating a control signal according to the touch signal or the image signal.

6. The display module of claim 5, wherein the display panel is configured to execute a corresponding operation according to the control signal generated by the processor.

7. The display module of claim 5, wherein the processor comprises:
a first processing unit, for receiving and processing the touch signal, and generating a first signal;
a second processing unit, for receiving and processing the image signal, and generating a second signal; and
a third processing unit, coupled to the first processing unit and the second processing unit, for receiving and processing the first signal or the second signal, and generating the control signal according to the first signal or the second signal.

8. The display module of claim 5, wherein the processor comprises:
a first processing unit, for receiving and processing the touch signal, and generating a first signal; and
a second processing unit, coupled to the first processing unit, for receiving and processing the image signal or the first signal, and generating the control signal.

9. The display module of claim 5, wherein the printed circuit board is a flexible printed circuit board.

10. The display module of claim 5, wherein when the processor receives the touch signal, the processor is configured to turn off the optical module.

11. The display module of claim 5, wherein when the processor receives the image signal, the processor is configured to turn off a sensor of the touch device.

12. The display module of claim 1, wherein an active area of the display panel corresponds to the first hole.

13. A display module, comprising:
a cover lens;
a decoration layer, arranged under the cover lens, having a first hole and at least one second hole, wherein the first hole is larger than the at least one second hole;
a display panel, arranged under the decoration layer;
a touch device, arranged above the display panel and corresponding to the first hole; and
at least one optical module, arranged under the cover lens and corresponding to the at least one second hole;
wherein the display panel is configured to execute a corresponding operation according to the touch signal or the image signal.

14. The display module of claim 13, wherein the first hole is filled with transparent gel.

15. The display module of claim 13, wherein the optical module comprises:
a lens, arranged under the cover lens for receiving light generated from at least one object via the second hole;
an image sensor, arranged under the lens for sensing the light generated from the at least one object, and generating a sensing signal according to the light generated from the at least one object; and
an image processor, for performing image processing to generate an image signal according to the sensing signal.

16. The display module of claim 15, wherein the image sensor is a charge coupled device (CCD) sensor or a complementary metal oxide semiconductor (CMOS) sensor.

17. The display module of claim 15, wherein the optical module further comprises:
an infrared light filter, attached between the cover lens and the lens for filtering out infrared light generated from the at least one object.

18. The display module of claim 13 further comprising:
a processor, coupled to the touch device and the optical module through a printed circuit board, for receiving and processing a touch signal and an image signal, and generating a control signal according to the touch signal and the image signal.

19. The display module of claim 18, wherein the display panel is configured to execute the corresponding operation according to the control signal generated by the processor.

20. The display module of claim 18, wherein the processor comprises:
a first processing unit, for receiving and processing the touch signal, and generating a first signal;
a second processing unit, for receiving and processing the image signal, and generating a second signal; and
a third processing unit, coupled to the first processing unit and the second processing unit, for receiving and processing the first signal or the second signal, and generating the control signal according to the first signal or the second signal.

21. The display module of claim 18, wherein the processor comprises:
a first processing unit, for receiving and processing the touch signal, and generating a first signal; and
a second processing unit, coupled to the first processing unit, for receiving and processing the image signal or the first signal, and generating the control signal.

22. The display module of claim 18, wherein the printed circuit board is a flexible printed circuit board.

23. The display module of claim 18, wherein when the processor receives the touch signal, the processor is configured to turn off the optical module.

24. The display module of claim 18, wherein when the processor receives the image signal, the processor is configured to turn off a sensor of the touch device.

25. The display module of claim 13, wherein an active area of the display panel corresponds to the first hole.
